(19) United States
(12) Patent Application Publication
(10) Pub. No.: US 2003/0127391 A1
(43) Pub. Date: Jul. 10, 2003

(54) Method for treatment of circulating cooling water

(76) Inventors: Frank S. Craft SR., Memphis, TN (US); David L. Drummonds, Homewood, AL (US); Shade M. Mecum, Charlotte, NC (US)

Correspondence Address: Ray F. Cox, Jr., Wright, Lindsey & Jennings LLP, Suite 2200, 200 West Capitol Avenue, Little Rock, AR, 72201, US

(21) Appl. No.: 09/916,060

(22) Filed: Jul. 26, 2001

(51) Int. Cl. B01D 61/00

(52) U.S. Cl. 210/651; 210/650; 210/652

(57) ABSTRACT

A method for the treatment of circulating cooling water to remove undesirable chemical, particulate and biological components to minimize fouling, scaling and corrosion. A saturated solution of calcium carbonate is maintained in a cross flow filtration system by controlling the concentration of precipitated salts, temperature and/or pH. The turbulent agitation of the water circulating in the cross flow filtration loop encourages the precipitation of the dissolved calcium carbonate from the saturated solution. The concentration of particulates in the cross flow filtration loop is controlled with respect to the filter membrane flux by balancing the rate of withdrawal of concentrate against the rate of addition of feed water from the circulating cooling water. Additionally, chemicals may be added to the circulating cross flow filtration loop to precipitate other dissolved chemicals. The cross flow filter may be a microfilter or a nanofilter. The permeate from the cross flow filter may be further polished with a nanofilter or reverse osmosis system. The reject from the nanofilter or the reverse osmosis system may be returned to the circulating cross flow filter loop to further enhance the kinetics of the precipitation reaction. Blowdown from the circulating cross flow filter loop (containing a slurry of precipitated chemicals) may be further concentrated with a dewatering device. The water separated from the slurry may then be returned to the circulating cross flow filter loop to enhance the precipitation kinetics.

### CROSS-REFERENCE TO RELATED APPLICATIONS

Not applicable

### STATEMENT REGARDING FEDERALLY SPONSORED RESEARCH OR DEVELOPMENT

Not Applicable.

### BACKGROUND OF THE INVENTION

1. Field of the Invention

The present invention relates to the treatment of solutions to remove dissolved substances, and in particular to the treatment of circulating cooling tower water to reduce fouling, corrosion and scaling and to control biological growth. More particularly, the present invention relates to a method for the treatment of water in which a cross flow filtration system is employed as a precipitator/reactor to remove dissolved scale forming substances as well as other dissolved and suspended matter.

2. Brief Description of the Related Art

Circulating cooling tower water looses water due to evaporation, which in turn leads to the concentration of the dissolved and suspended particulate matter in the water. At greater concentrations, dissolved matter may eventually reach a saturated condition which encourages the formation of more particulates or the deposition of solids as scale on the surfaces of the system. Suspended particulate matter may settle and foul portions of the system and may also serve as a substrate for the development and growth of biological film on surfaces. Careful control of these factors is necessary to avoid loss of efficiency in the cooling system and the potential for damage due to corrosion, fouling and scaling of equipment surfaces.

Circulating cooling tower water may be treated by various means to avoid these problems. Conventional treatment of circulating cooling tower water includes chemical treatment, external treatment and electrostatic treatment. The objective of such treatment of the circulating water is to prevent fouling, scaling and corrosion of process equipment, to minimize water and chemical use, and to protect the environment while operating the cooling system at maximum cycles of concentration with minimum or zero blowdown.

In chemical treatment, chemicals such as mineral acids, polyphosphates, phosphonates and organic polymers may be used to reduce scaling. Also, chemicals such as zinc polyphosphates, zinc orthophosphates, and zinc organo-phosphorous compounds may be used to inhibit metallic corrosion. However, if chemicals are not used properly, corrosion of metals and precipitation of insoluble salts can occur.

Other chemical treatment includes the use of biocides for controlling microbiological growth to prevent corrosion, fouling and scaling in cooling water systems. Commonly employed biocides are chlorine, bromine and chlorine dioxide.

Deposition of suspended solids provides a substrate for microbiological activity. Deposition of solids may be controlled by using a dispersant to increase the electrical repulsion between particles and prevent them from agglomerating and settling. The suspended material is then removed from the system by conventional methods, such as filtration. Dispersants may also be used to prevent scale deposition on heat transfer surfaces.

An alternative to chemical treatment is external treatment, which includes blowdown of the circulating water, side stream filtration, and side stream softening.

The levels of dissolved salts, alkalinity and suspended particulates in the circulating cooling water can be reduced by increasing the rate of blowdown. A major drawback of increasing the rate of blowdown is the necessary increase in makeup water, increased chemical usage and increased wastewater. More wastewater means that more pollution, including thermal pollution, is discharged from the system.

Side stream processes take a stream from the main circulating cooling water stream and divert through a treatment process before it is returned to the main circulating cooling water stream. Side stream filters remove particulate material from the circulating cooling water to minimize fouling. A conventional side stream filter, such as a sand filter, can remove larger particulate material, but typically does not remove smaller particulates effectively. Side stream softeners are chemical processes that may be used to remove dissolved matter from the circulating cooling water. Chemical precipitants are added to the side stream to cause the precipitation of dissolved constituents of the cooling water. Precipitates are subsequently removed by filtration.

Electronic devices have also been suggested for water treatment. The most success has been had with electrostatic devices that affect the zeta potential of the particles in the water, causing the particles and the surfaces of the cooling system to be electrically charged, thereby establishing a repulsion that prevents agglomeration and settling of the suspended particles. Electronic dispersion methods and apparatus applicable to circulating cooling tower water are disclosed in U.S. Pat. Nos. 5,817,224 and 5,591,317.

Other attempts to address the problem of treating circulating cooling tower water can be found in various U.S. patents. U.S. Pat. No. 4,981,594 discloses a purification system for cooling tower water using nanofiltration in combination with ionization. U.S. Pat. No. 4,670,150 discloses a cross flow microfiltration water softener utilizing lime addition.

U.S. Pat. No. 5,858,240 discloses a nanofiltration process to selectively change the concentration of one solute providing monovalent ions from another solute to provide multivalent ions. The process is stated to be particularly useful in favorably lowering the concentration of undesirable ions in chloralkali and chlorate brine containing solutions and favorably raising the sodium sulfate level relative to sodium chloride in chloralkali liquor.

U.S. Pat. No. 5,527,466 discloses an apparatus and method utilizing cross flow filtration under supercritical conditions for water to separate/filter a feed stream or reaction mixture.

References mentioned in this background section are not admitted to be prior art with respect to the present invention.

The limitations of the prior art are overcome by the present invention as described below.

### BRIEF SUMMARY OF THE INVENTION

The present invention is directed to a process for the removal of dissolved substances from a solution and in particular to the treatment of circulating cooling water to inhibit fouling, scaling and corrosion by removing dissolved and suspended matter from the circulating water. Calcium carbonate is a normal constituent of cooling water and a primary consideration in minimizing scaling and corrosion. Calcium carbonate may be present in both dissolved and precipitated form. When the calcium carbonate is in equilibrium, there is no tendency for calcium carbonate to precipitate and form deposits on pipes and other surfaces nor is there a tendency for calcium carbonate to dissolve coatings that may protect against corrosion. The Langelier Saturation Index (“LSI”) is a measure of the tendency of the calcium carbonate to either precipitate or dissolve based on the degree of saturation of the water with calcium carbonate. The Langelier Saturation Index is defined as the difference between the actual pH and the equilibrium pH value. If the Langelier Saturation Index is positive, calcium carbonate tends to precipitate and scale formation occurs. If the index is negative, then calcium carbonate will tend to dissolve, there is no potential to scale and corrosion may be enhanced. Among the factors that influence the magnitude of the Langelier Saturation Index are the alkalinity, the calcium hardness, the total dissolved solids, the actual pH, and the temperature of the water.

The solubility of a substance in water is generally temperature-dependent. For most substances soluble in water, the solubility increases as the temperature increases. Some substances, such as calcium carbonate, however, show a decreasing solubility as the water temperature increases.

Colloidal substances are minute finely-divided particles whose characteristic properties are derived from their large surface areas. For example, colloids have an outstanding ability to concentrate substances on their surfaces through adsorption or chemical reaction on their large surface areas. Colloids also tend to develop charges on their surfaces. Colloids will tend to aggregate to form larger particles unless they are stabilized in some way. The stability of colloids may depend upon the magnitude of the zeta potential, which is a measure of the charge on the colloid and the distance from the particle that the charge is effective. The zeta potential may be altered to stabilize a population of colloids or to disperse aggregated colloids. All fine particles partake of these properties in a greater or lesser degree whether they are strictly defined as colloids or not.

Cooling towers desirably operate at maximum cycles of concentration with minimum blowdown. However, this operating regime results in the increasing concentration of various dissolved substances, particularly calcium carbonate, which increase the scaling potential. Increasing blowdown is one answer to limit the increasing concentration of scale forming substances, but this solution suffers from environmental problems and costs due to the need for more makeup water, more chemical addition and more pollution, including thermal pollution. The value of blowdown is at least partially offset by the addition of more makeup water, which may contain dissolved and suspended solids and microorganisms, so that more makeup water continues the problems caused by these substances. In order to avoid these problems, it is desirable to remove the calcium carbonate by some means other than increasing blowdown or using chemical additives. Suspended particles of calcium carbonate may be removed by filtering. However, since calcium carbonate is present in cooling water in both dissolved and particulate form, and further since the calcium carbonate will generally be present in a saturated condition (Langelier Saturation Index positive) tending to cause the dissolved calcium carbonate to precipitate on surfaces in the cooling system, removing suspended particulate calcium carbonate alone is not a sufficient solution to the problem of preventing scaling in a cooling system.

The present invention controls the conditions in a cross flow filtration system, preferably a membrane type cross flow filtration system, to enhance the kinetics of the precipitation reaction for a dissolved chemical substance in order to efficiently remove the dissolved substance from the solution as a precipitate.

In a cross flow membrane filtration system; the solution to be filtered is re-circulated from a feed tank across the filter membrane and back to the feed tank. The filtrate or liquid that passes through the membrane is called the “permeate”, and the materials that do not pass through the membrane are called the “retentate”. The retentate is re-circulated and re-filtered until the solids concentration in the retentate increases to the point of reducing the flux rate, i.e., the rate of permeate production through the membrane. The reduction in flux rate can be caused by fouling of the membrane or by slower velocity due to the increased viscosity and density of the retentate. By introducing a fresh feed stream into the retentate, the flux rate of permeate is increased. Concentrated retentate is removed (or blown-down) from the system for disposal (or further dewatering). Controlling the rate at which substances are removed from or introduced into the system determines the concentration in the retentate.

The concentration of solids and salts in the retentate is considerably higher than the feed stream. The system is operated at concentrations that give the optimum flux rate of the filter membrane considering the cost of disposal or dewatering of the retentate blow-down. This optimum retentate solution will vary from site to site depending on the specific salts and their molar ratio in the makeup to the system.

Precipitation in the cross flow filter may also be enhanced by controlling such factors affecting the solubility of the dissolved chemical species as the temperature or the pH of the solution depending upon the particular chemical species and solvent in which it is dissolved.

The retentate has salt crystals from precipitation and the liquid is saturated with ions of the salt in solution. A cross flow filter system operates with a high shear rate in the highly turbulent circulating retentate stream which promotes intimate contact between the precipitated salt crystals and other particulates and the saturated liquid and therefore encourages rapid and efficient precipitation of the salts from the saturated solution onto the surfaces of the precipitated salts and other particulates to seed the precipitation reaction. At the same time, the retentate is being concentrated by the flux of permeate through the membrane, thereby shifting the retentate to the precipitation side of the solubility constants. This not only creates an efficient and rapid precipitation reaction, but also increases the size of the precipitated crystals thus promoting more effective separation from the retentate through the membrane. Additionally, the retentate can be further seeded with crystals and other particulates to accelerate the precipitation reaction.

The enhanced reaction kinetics of the present invention therefore is the result of (1) controlling the concentration of precipitates in the retentate to shift the retentate to the precipitation side of the solubility constants, (2) controlling other factors affecting solubility of the dissolved substances including temperature and pH of the retentate, (3) turbulenting agitating the retentate to promote contact between the precipitated salts and other particulates and the dissolved ions in the retentate, and (4) introducing seed materials, such as fine particulates (e.g., colloidal particles) and precipitated crystals, into the retentate.

The same approach is effective in enhancing the kinetics of other reactions in the cross flow filtration system. For example, if it is desired to remove organics from the retentate, organic scavengers such as adsorbents may be added to the retentate. Due to the high shear turbulent conditions in the cross flow membrane, efficient contact between the organics and the adsorbent increases the contact kinetics with the adsorbent. Enhanced reaction kinetics would also occur with other chemical reactions that could take place simultaneously in the same cross flow filter reactor as the enhanced precipitation reaction described above. Such enhanced reactions could include: adding magnesium hydroxide to react with silica to remove silica from the retentate, adding lime/soda for softening water, adding chemical dispersants to minimize membrane fouling, efficient utilization of electronic dispersant devices to minimize fouling, adding biocides for controlling microbial matter, adding activated carbon or quaternary treated bentonite to absorb hydrocarbons, and adding coagulants and wetting agents to influence behavior of the suspended solids.

While the enhanced precipitation reaction of the present invention may be applied to various solvent/solute systems, in the preferred embodiment of the present invention, calcium carbonate is removed as particulate calcium carbonate in a cross flow filtration system by encouraging the precipitation of the dissolved calcium carbonate, particularly onto salt crystals or other high surface area particles, such as colloidal particles. This is accomplished by ensuring that calcium carbonate is maintained as a saturated solution in the cross flow filtration system (for example, by controlling the concentration of calcium carbonate particles, the temperature of the retentate and the pH of the retentate). Furthermore, precipitation is encouraged by enhancing the population of all particles, including calcium carbonate, in the cross flow filtration system to provide a large effective surface area onto which the dissolved calcium carbonate will tend to precipitate. In addition, the cross flow filtration system may encourage precipitation by increased contact due to the turbulent recirculating flow within the cross flow filtration system. The present invention may also be employed to remove dissolved substances other than calcium carbonate from water in the same manner. However, for circulating cooling water, calcium carbonate is the primary problem to be addressed for the control of scaling. Calcium carbonate may be removed by this method and, in addition, other dissolved substances may be removed by adding a precipitant specific to the substance to be removed. Thus, the present invention may be employed to simultaneously remove both dissolved calcium carbonate and other undesirable substances, such as silica by enhancing the precipitation reaction for calcium carbonate as described above and enhancing the precipitation reaction of the other dissolved substances with the added precipitant.

The present invention uses cross flow filtration to remove suspended particles and to act as a precipitator/reactor as described above. Cross flow filtration differs from “dead end” filtration in that the feed water flows perpendicular to the filter surface at a high enough flow rate to avoid the buildup of solids on the filter surface. The circulating feed water therefore exhibits an increasing concentration of suspended material which is removed as a concentrate stream. The size of the particles retained in the circulating feed water may be determined by the type of filter surface. In cross flow filters utilizing nanofilters or reverse osmosis membranes, the “particles” may be molecular in size. Even microfilters may be effective in removing microorganisms that contribute to scaling, fouling and corrosion.

In one preferred embodiment a side stream cross flow microfiltration system is installed on the hot side of a heat exchanger to enhance membrane flux and calcium carbonate precipitation. The thorough mixing and concentration process within the microfilter circulation loop functions as a reactor/precipitator to cause dissolved scale forming substances to precipitate from a saturated solution. With this system, cooling tower cycles of concentration can be increased with the higher concentrated discharge stream from the membrane system being converted into the cooling system blowdown or dewatered for disposal at landfills. Benefits include reduced blowdown water to waste, reduced thermal pollution to waste, reduced makeup water, reduced chemical consumption, and reduced fouling and deposition of scale, suspended solids and microorganisms.

Alternatively, a side stream cross flow microfiltration system may be employed as an enhanced reactor by the addition of a chemical feed system and pH monitor for controlled addition of precipitant (caustic, lime, magnesium hydroxide, etc.) to a filter system feed tank to enhance precipitation of calcium salts and silica to be separated from the circulation system. An adsorbent or absorbent material (activated carbon, etc.) may be added to the feed tank to reduce levels of organics, such as hydrocarbons.

A further alternative embodiment employs the side stream cross flow microfiltration system with a nanofiltration system or reverse osmosis system as a polisher. The entire microfiltration permeate stream or a side stream can be treated with the polisher. The concentrated reject from the nanofiltration system or reverse osmosis system (or a portion of it), can be returned to the microfiltration feed tank to enhance precipitation in the microfilter. The reject or concentrate stream from the nanofilter or reverse osmosis system can be split so that a portion can be recycled to the microfilter/reactor feed and the balance discharged as waste.

A still further alternative embodiment would employ the side stream cross flow microfiltration system with both the precipitation reactor system and nanofiltration.

The side stream cross flow system may also employ nanofiltration rather than microfiltration. The nanofilter would employ durable wide channel nanofiltration membranes or a nanomembrane applied to a microfiltration membrane, allowing for a single nanofiltration system rather than a microfilter followed by a polymeric nanofilter.

Any of the alternatives outlined above could be employed with chemical dispersion or with electronic dispersion. The addition of electronic dispersion would help to 1) inhibit scaling of cross flow membranes allowing higher recovery and minimizing backpulsing and membrane cleaning, 2) inhibit scaling of cooling system components allowing for higher cycles of concentration and reducing or eliminating chemical dispersants, and 3) decreasing microbiological activity and reducing or eliminating need for biocides. The chemical or electronic dispersion systems could be located on the same side stream with the cross flow filtration/reactor system, on a separate side stream, or in the main recirculation stream.

As a final alternative embodiment, the concentrate from the cross flow filter could be fed to a dewatering device to approach zero water discharge. The reclaimed water from the dewatering device may be returned to the cross flow filtration system to enhance the calcium carbonate precipitation.

These and other features, objects and advantages of the present invention will become better understood from a consideration of the following detailed description of the preferred embodiments and appended claims in conjunction with the drawings as described following:

### BRIEF DESCRIPTION OF THE SEVERAL VIEWS OF THE DRAWINGS

FIG. 1 is a flow diagram of the method of the present invention.

### DETAILED DESCRIPTION OF THE INVENTION

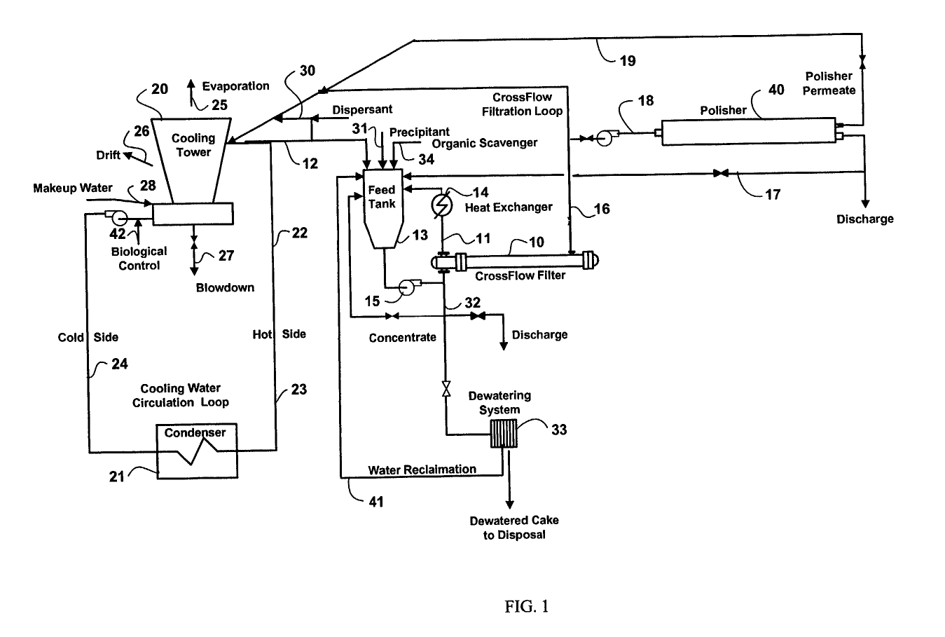

With reference to FIG. 1, the preferred embodiments of the present invention may be described. The present invention treats cooling water in a cooling system. Generally, such a cooling system involves circulating water through a cooling tower 20 and condenser 21 in a cooling water circulation loop 22. Although the description of the preferred embodiment is given in relation to a cooling system circulating water through a condenser, the present invention is not limited to condensers, but may be practiced with any type of heat exchanger including a cooler. The present invention is also not limited to cooling tower circulating water nor to solutions of water. The circulation loop 22 has a hot side 23 exiting from the condenser 21 and a cold side 24 entering the condenser 21. The circulation loop 22 is not closed since water is lost through evaporation 25 and drift 26, which is made up for by the addition of makeup water 28. The evaporation losses 25 tend to concentrate the constituents in the makeup water 28 so that periodical blowdown 27 of the circulating water is required to prevent the buildup of constituents that would tend to deposit as scale on the condenser 21 and other components of the cooling system. One of the major scale-forming constituents that can build up in circulating cooling water is calcium carbonate (CaCO₃).

In the preferred embodiment of the present invention, calcium carbonate is removed as particulate calcium carbonate in a cross flow filtration system comprising a cross flow filter 10 with water circulating in a cross flow filtration loop 11. A feed stream is taken as a side stream 12 from the cooling water circulation loop 22 to a feed tank 13. The water flows from the feed tank 13 through the cross flow filter 10 and back to the feed tank 13 thus completing the cross flow filtration loop 11. The permeate stream 16 from the cross flow filter 10 is returned to the cooling water circulation loop 22.

The retentate circulating in the cross flow filtration loop 11 is maintained as a saturated solution with respect to the calcium carbonate (Langelier Saturation Index is positive). Since the calcium carbonate is in a saturated solution, the precipitation of dissolved calcium carbonate is encouraged. This saturated condition is accomplished by various means. For example, controlling the pH in the retentate circulating in the cross flow filtration loop 11 will allow the pH to be adjusted to the point where the solution is saturated at that pH. Also, specific anions or cations may be added to the retentate to produce a saturated solution. Controlling the temperature in the retentate is a straightforward way of ensuring that the retentate is in a saturated condition. By adding a heat exchanger 14 to the cross flow filtration loop 11, the concentrated solution circulating in the cross flow filtration loop 11 may be heated or cooled as necessary to ensure that the concentrate is saturated with respect to that temperature. Since calcium carbonate is less soluble at increasing temperatures, the appropriate temperature may also be achieved by taking the feed stream to the cross flow filtration loop 11 from the hot side 23 of the circulating cooling water loop 22. Furthermore, the pump 15 may be used to add heat to the filtration loop 11 by circulating the retentate for a period of time to build up heat by friction and the mechanical agitation of the retentate. Other sources of heat include boiler blowdown water, steam, or even heat from solar collectors.

Either alone or in combination with these approaches, the saturation of the concentrated retentate in the cross flow filtration loop 11 may be maintained by controlling the cycles of concentration in the circulating cooling water loop 22. Normally, a cooling system will be operated so that the calcium carbonate will not precipitate and form scale. Operating the cooling system at cycles of concentration that produce a highly saturated condition with respect to calcium carbonate would not be desirable. With the present invention, the cooling water loop 22 and the cross flow filtration loop 11 may be operated independently so that the concentration of calcium carbonate in one is independent of the concentration in the other. However, if a cooling system were operated in this mode to produce a saturated feed to the cross flow filtration loop 11, the undesirable side effect of scaling in the cooling system may be minimized by utilizing a dispersant 30, either chemical or electronic, applied directly to a dispersant side stream from the cooling water circulation loop 22 to lower the scaling tendency in the hot side 23.

The dispersant 30 also tends to promote the stability of colloids and other fine particles formed in the cooling water circulation loop 22 and in the cross flow filtration loop 11. The presence of high surface area colloids or other fine particles encourages the precipitation of calcium carbonate in the cross flow filtration loop 11, since these small particles provide a large effective surface area onto which the dissolved calcium carbonate will tend to precipitate. In addition, precipitation is encouraged by the cross flow filter 10 since it enhances the concentration of substances retained in the cross flow filtration loop 11. Further, the cross flow filter 10 encourages precipitation by enhanced contact due to the highly turbulent agitation produced by the recirculating flow within the cross flow filtration loop 11. The growth of small particles into larger particles by the precipitation of calcium carbonate onto their surfaces enhances the efficiency with which these larger particles are removed by the cross flow filter 10. The present invention may also be employed to removed dissolved substances other than calcium carbonate from water in the same manner. However, for circulating cooling water, calcium carbonate is the primary problem to be addressed for the control of scaling.

Calcium carbonate may be removed by this method without the addition of chemical precipitants to the water. In addition to the removal of calcium carbonate by this method, other dissolved substances may be removed by the addition of a chemical feed system and pH monitor for controlled addition of precipitant 31 (caustic, lime, magnesium hydroxide, etc.) to the feed tank 13 to enhance precipitation of other salts and silica. An organic scavenger 34, such as activated carbon, bentonite, etc., may be added to the feed tank 13 to reduce levels of organics, such as hydrocarbons. Thus, the present invention may be employed to simultaneously remove both dissolved calcium carbonate and other undesirable substances, such as silica which may be precipitated by the addition of magnesium hydroxide. The cross flow filter 10 of the present invention not only enhances both the precipitation of calcium carbonate but the same factors of turbulent agitation, concentration of particulates in the cross flow filtration loop 11 and/or control of temperature and pH promote the reaction kinetics of any other precipitation reaction in the cross flow filtration loop 11.

The cross flow filter both concentrates suspended particles and acts as a precipitator/reactor as described above. Cross flow filtration differs from “dead end” filtration in that the feed water flows perpendicular to the filter surface at a high enough flow rate to avoid the build up of solids on the filter surface. The water circulating in the cross flow filtration loop 11 therefore exhibits an increasing concentration of suspended material which is removed as a concentrate stream 32. The concentrate stream 32 may be returned to the feed tank 13 to further seed the precipitation reaction, sent to a dewatering system 33 or discharged as a waste. The size of the particles retained in the cross flow filtration loop 11 is determined by the type of filter surface. In cross flow filters utilizing nanofilters or reverse osmosis membranes, the “particles” may be molecular in size. The permeate from the cross flow filter 10 may be returned to the cooling water circulation loop 22 or further polished as described below.

In the preferred embodiment, the cross flow filter 10 is a self-cleaning cross flow microfiltration membrane system with durable, wide channel membranes, such as sintered metal or ceramic or a moving membrane system such as VSEP (New Logic Co.) or Spintech, preferably capable of cyclic automatic backpulsing to maintain consistent membrane flux.

In a further alternative embodiment of the present invention, the permeate from the cross flow filter 10 is polished in a polisher 40, either a nanofiltration system or reverse osmosis system (spiral wound, tubular, ceramic, or other form of cross flow nanofiltration or moving membrane such as a New Logic VSEP or Spintech type). The entire permeate stream 16 or a side stream can be treated with the polisher. The concentrated reject stream 17 from the polisher 40 (or a portion of it), can be returned to the feed tank 13 to enhance precipitation and rejection in the cross flow filter 10. The reject stream 17 from the polisher 40 contains both dissolved and particulate material concentrated from the upsteam feed and therefore actively seeds the precipitation processes in the cross flow filtration loop 11. Because the feed 18 to the polisher 40 has been filtered to submicron levels of particulate material and hardness has been reduced to relatively low levels by the cross flow filter 10, a nanofilter, an ultrafilter or a reverse osmosis system with a membrane prone to fouling, such as a spiral wound or hollow fiber type, can be used as the polisher 40. Without this thorough pretreatment, it would be impractical to use such readily available and economical membranes on such a severe application. The reject stream 17 from the polisher 40 can be split so that while a portion can be recycled to the feed tank 13, the balance can be discharged as waste. In order to control the level of concentration of constituents that could foul the polisher 40, the ratio of reject flow discharged to the flow recycled can be increased and/or the recovery rate of the polisher 40 can be reduced. The polisher permeate stream 19 is returned to the cooling water circulation loop 22.

The cross flow filter 10 may also employ nanofiltration rather than microfiltration. The nanofilter would employ durable wide channel nanofiltration membranes or a nanomembrane applied to a microfiltration membrane, allowing for a single nanofiltration system rather than a microfilter followed by a polymeric nanofilter.

Any of the alternatives outlined above could be employed with dispersion 30, either chemical or electronic. The addition of electronic dispersion would help to 1) inhibit scaling of cross flow membranes allowing higher recovery and minimizing backpulsing and membrane cleaning, 2) inhibit scaling of cooling system components allowing for higher cycles of concentration and reducing or eliminating chemical dispersants, and 3) decreasing microbiological activity and reducing or eliminating need for biocides. The chemical or electronic dispersion systems could be located on the same side stream with the cross flow filter 10 or could be on a separate side stream or in the cooling water circulation loop 22.

If the concentrate 32 from the cross flow filter 10 is fed to a dewatering system 33, the invention will approach zero water discharge. The dewatering system 33 could be a precipitation tank, a combination of precipitation tank and filter press, a moving membrane system such as a New Logic VSEP or Spintech type, with or without a precipitation tank, a belt press, a centrifuge, or a dead end filter. The reclaimed water stream 41 from the dewatering system 33 contains both dissolved and suspended materials, such as colloidal particles. The reclaimed water stream 41 may be recycled to the feed tank 13 to further seed the precipitation reactions in the cross flow filtration loop 11.

Finally, biological control 42 may be employed in conjunction with any of the embodiments described above. Biological control chemicals would desirably fed to the cold side 24 of the condenser 21 to keep the condenser free of biological fouling.

The following examples represent bench-scale testing of the present invention. The examples employed various filter membranes as noted in the accompanying tables. The Graver® 0.1 micron membrane is a sintered metal (stainless steel) tubular housing with a proprietary (TiO₂) membrane coating. The Duramem® membrane is a ceramic structure with the following coatings: the 0.01 micron membrane has a titania coating and the 0.2 micron membrane has an α-alumina coating. These are representative of various types of membranes that may be used in the practice of the present invention. The operational parameters of the tests were selected based on prior engineering experience with these types of membranes and do not reflect the full range of operational parameters available to be used with these membranes.

Some of the tests also included the use of electronic dispersion in conjunction with cross flow filtration. The particular type of electronic dispersion device used in the tests is know as the Zeta Rod manufactured by Zeta Corporation. The Zeta Rod used in the experimental examples was an 18 inch, 30,000 volt model used to produce an electrostatic dispersant effect. This is only one of many electrostatic dispersant devices that could be used in the practice of the present invention. Chemical dispersants known in the prior art are also available that can achieve similar results.

The initial phase of testing the present invention involved trials using each membrane type without the electronic dispersion unit. This testing was done in order to have baseline data with which to compare the later results using the same membranes in conjunction with the Zeta electronic dispersion unit.

### EXAMPLE 1

For the initial testing, 20 gallons of deionized water were placed in the feed tank of a skid-mounted testing unit. The unit was equipped with a 0.1-micron nominal pore size Graver® stainless steel tubular membrane with 0.377 ft² of surface area that had previously been cleaned and tested using deionized water. The 20 gallons of water were circulated through the unit, with the membrane bypassed, while being heated to 100-110° F. After achieving temperature stabilization, 21.7865 grams of mixed salts were added to the water and circulated. This addition represented 50% of the hardness and silica chosen as representative of a typical cooling tower water chemistry (0.5×). This 21.7865-gram addition was one-sixth of the total addition that would eventually be mixed into the deionized water, which would represent 300% (3.0×) of the typical desired concentration for cooling tower water streams. The total mixture of salts that was added contained the following:

Calcium carbonate: 61.3173 grams

Calcium chloride dihydrate: 10.0124 grams

Magnesium carbonate: 5.7276 grams

Magnesium sulfate: 18.7707 grams

Sodium carbonate: 24.1508 grams

Sodium meta-silicate (Na₂SiO₃*9H₂O): 10.7384 grams

After addition of the initial 21.7865 grams of salts, the solution was allowed to contact the membrane. Testing parameters were then established at 100-psi inlet pressure, 15-fps cross-flow velocity (corresponding to 19.6 gpm feed to the membrane), at 100-110° F. This set of conditions was maintained for one hour with pressure, temperature, permeate and cross-flow rates obtained and recorded every 15 minutes and samples of the permeate and feed taken after 30 minutes of operation. After one hour, the membrane was backpulsed (with 80-psi nitrogen and the feed pump off), and then isolated. A second addition of 21.7873 (1.0×) grams of mixed salts were then added to the solution, which was again circulated, reheated to 100-110° F., then allowed to contact the membrane at the above testing conditions. Testing continued in this manner, with four more hourly salt additions of 21.7867 (1.5×), 21.7702 (2.0×), 21.7879 (2.5×), and 21.7986 grams (3.0×).

At the conclusion of the above testing, the Graver® membrane was removed from the testing rig, and a previously tested and cleaned 0.2-micron nominal pore size Duramem® ceramic membrane with 1.2 ft² of filtration surface area was installed. The concentrated salt solution was then allowed to contact the ceramic membrane and the membrane was tested several data points: 28 psi, 50 psi, and 75 psi at 8 (8.2-8.6) and 14.0 (14.1-14.2) gpm feed rates. (These represent approximately 7 and 12 ft/sec cross flow velocity.) The testing was done for one hour, with readings taken every fifteen minutes. After this testing, the 0.2-micron unit was removed, and a 0.01-micron Duramem® unit with the same surface area and flow configuration was installed. This unit was tested using the same temperature, pressure, and cross-flow rates as the 0.2-micron unit for one hour. The experimental results are set forth in the following tables. Tables 1A and 1B are formatted separately for clarity but should be read together as a single table. This is likewise true for Tables 2A and 2B and for all other tables set forth with the subsequent examples.

TABLE 1A

| | | Membrane Feed | |
|---|---|---|---|
| Membrane | Concentration | PSI | Mem. Outlet PSI |
| 0.1 Graver | 1X | 100 | 94 |
| | 1.5X | 100 | 94 |
| | 2.0X | 100 | 94 |
| | 2.5X | 100 | 94 |
| | 3.0X | 100 | 94 |
| 0.1 Graver | 3.0x | 100 | 96 |
| 0.2 Duramem | 3.0X | 28 | 25 |
| | 3.0X | 50 | 40 |
| | 3.0X | 75 | 65 |
| 0.01 Duramem | 3.0X | 28 | 22 |
| | 3.0X | 50 | 35 |
| | 3.0X | 75 | 62 |

TABLE 1B

| | Conc. Temp. | Conc. Flow | Perm. Flow | Perm flow | (GFD)/ |
|---|---|---|---|---|---|
| TMP | (° F.) | (gpm) | (ml/min) | (GFD) | TMP |
| 97 | 107 | 19.6 | 847 | 854.6 | 8.8 |
| 97 | 107 | 19.6 | 821 | 828.4 | 8.5 |
| 97 | 108 | 19.6 | 1195 | 1205.8 | 12.4 |
| 97 | 107 | 19.6 | 1304 | 1315.7 | 13.6 |
| 97 | 106 | 19.6 | 1226 | 1237.0 | 12.8 |
| 98 | 106 | 19.6 | 1071 | 1080.6 | 11.0 |
| 26.5 | 107 | 8.2 | 3181 | 1009.8 | 38.1 |
| 45 | 105 | 14.1 | 4800 | 1523.8 | 33.9 |
| 70 | 107 | 14.2 | 6960 | 2209.5 | 31.6 |
| 25 | 105 | 8.6 | 1735 | 550.8 | 22.0 |
| 42.5 | 105 | 14.2 | 2820 | 895.2 | 21.1 |
| 68.5 | 104 | 14.2 | 4468 | 1418.4 | 20.7 |

TABLE 2A

| | | | Conductivity | | | | | |
|---|---|---|---|---|---|---|---|---|
| | pH | | (micromhos) | | Ca (ppm) | | Mg (ppm) | |
| Concentration | Conc. | Perm. | Conc. | Perm. | Conc. | Perm. | Conc. | Perm. |
| 1X | 9.71 | 9.72 | 388 | 375 | 85.9 | 6.9 | 23.3 | 20.7 |
| 1.5X | 9.86 | 9.91 | 520 | 526 | 126.5 | 10.5 | 34.6 | 26.74 |
| 2.0X | 9.83 | 9.89 | 571 | 579 | 155.2 | 8.4 | 44.7 | 25.8 |
| 2.5X | 9.84 | 9.88 | 681 | 671 | 219 | 2.1 | 56.9 | 27.3 |
| 3.0X | 9.88 | 9.87 | 778 | 776 | 241 | 2.3 | 70.4 | 33 |
| 3.0X | 9.88 | 9.58 | 778 | 765 | 241 | 1.9 | 70.4 | 27.4 |
| 3.0X | 9.88 | 9.68 | 778 | 762 | 241 | 1.75 | 70.4 | 26.5 |

TABLE 2B

| | | | | Silt | | Total Alkalinity |
|---|---|---|---|---|---|---|
| Total Hardness | | | | Density | P-Alkalinity | (meq/l) |
| (ppm CaCO₃₎ | | SiO₂ (ppm) | | Index | (meq/l) | (pH 7) |
| Conc. | Perm. | Conc. | Perm. | Perm. | Perm. | Perm. |
| 306 | 90 | 29.3 | 29.2 | 0.21 | 0.5 | 0.75 |
| 420 | 120 | 27.1 | 29.6 | | | |
| 496 | 110 | 25.7 | 28.3 | | | |
| 720 | 100 | 24.2 | 25.4 | | | |
| 880 | 100 | 21.9 | 24.6 | 0.75 | 1 | 1.25 |
| 880 | 122 | 21.9 | 16.8 | 0.98 | 0.85 | 1.1 |
| 880 | 120 | 21.9 | 17 | 0.63 | 0.7 | 1.1 |

### EXAMPLE 2

After this testing, the 0.01-micron Duramem® unit was used to concentrate the salt solution. The permeate from the membrane was taken off to a separate container, and the feed solution concentrated to 25% of its original volume (5 gallons), with readings and feed and permeate samples taken every 12.5% (2.5 gallons). After reaching 75% feed concentration, the solution was circulated for one hour at testing parameters (14 gpm feed flow and 75 psi feed pressure), with the permeate redirected back to the feed tank. Afterwards, the salt solution was drained from the system and the testing skid rinsed. Results are provided in Tables 3A-4B following.

TABLE 3A

| | | Mem. | Mem. | |
|---|---|---|---|---|
| Membrane | Concentration | Feed PSI | Outlet PSI | TMP |
| 0.01 | 3X | 75 | 62 | 68.5 |
| Duramem | 12.50% | 75 | 62 | 68.5 |
| | 25% | 75 | 62 | 68.5 |
| | 37.50% | 75 | 62 | 68.5 |
| | 50% | 75 | 62 | 68.5 |
| | 62.50% | 75 | 62 | 68.5 |
| | 75% | 75 | 62 | 68.5 |
| | 75% | 75 | 62 | 68.5 |

TABLE 3B

| Conc. Temp. | Conc. Flow | Perm. Flow | Perm | |
|---|---|---|---|---|
| (° F.) | (gpm) | (ml/min) | flow (GFD) | GFD/TMP |
| 103 | 14.1 | 4400 | 1396.8 | 20.4 |
| 105 | 14 | 4131 | 1311.4 | 19.1 |
| 105 | 14 | 4080 | 1295.2 | 18.9 |
| 104 | 14 | 3930 | 1247.6 | 18.2 |
| 104 | 14 | 3990 | 1266.7 | 18.5 |
| 104 | 14 | 3828 | 1215.2 | 17.7 |
| 104 | 14 | 3900 | 1238.1 | 18.1 |
| 105 | 14 | 3710 | 1177.8 | 17.2 |

TABLE 4A

| | | | | Conductivity | |
|---|---|---|---|---|---|
| | | pH | | (micromhos) | |
| Membrane | Concentration | Conc. | Perm. | Conc. | Perm. |
| 0.01 Duramem | 25% | 9.65 | 9.52 | 805 | 774 |
| | 50% | 9.66 | 9.53 | 808 | 766 |
| | 75% | 9.68 | 9.52 | 807 | 770 |

TABLE 4B

| | | | | Total Hardness (ppm | | | |
|---|---|---|---|---|---|---|---|
| Ca (ppm) | | Mg (ppm) | | CaCO₃) | | SiO₂ (ppm) | |
| Conc. | Perm. | Conc. | Perm. | Conc. | Perm. | Conc. | Perm. |
| 313 | 2.2 | 79.1 | 29.6 | 1094 | 116 | 21.4 | 16.7 |
| 451 | 2.1 | 92.5 | 31.5 | 1485 | 112 | 24.1 | 15.7 |
| 708 | 2.1 | 124.7 | 30.4 | 2578 | 122 | 29.8 | 17.2 |

### EXAMPLE 3

After cleaning the testing skid, an ESNA-Free 350 thin-film composite nanofiltration membrane with 17 ft² of filtration surface area was installed. The 15 gallons of microfiltration permeate was placed in the feed tank and circulated while being heated to 100-110° F. After temperature stabilization, the solution was passed through the nanofilter at 140-psi inlet pressure and 16.0 gpm feed rate. These conditions were maintained for two hours, with temperature, pressure, flow rate, and feed and permeate conductivity readings taken every 30 minutes. The inlet pressure was then dropped to 100 psi, the feed rate decreased to 7.0 gpm, and these conditions were maintained for two hours, with 30-minute readings obtained. The previous set of conditions were then restored, and the membrane used to concentrate the microfiltration permeate to 50% of its original volume (7.5 gallons) with the permeate taken off to a separate container. Readings and feed and permeate samples taken every 1.5 to 2 gallons of permeate (10 to 13.3% feed concentration). The concentrated solution was then circulated for one hour with 30-minute readings obtained. The testing skid was then drained, and the skid, nanofilter, and three microfiltration membranes were cleaned. Experimental results are shown in Tables 5A-6B.

TABLE 5A

| | | | | | Conc. |
|---|---|---|---|---|---|
| | | Mem. Feed | Mem. Outlet | | Temp. |
| Membrane | Concentration | (PSI) | (PSI) | TMP | (° F.) |
| Nano 350 | Initial 1 | 140 | 126 | 133 | 106 |
| | Initial 2 | 99 | 96 | 97.5 | 108 |
| Nano 350 | 10% | 140 | 126 | 133 | 106 |
| | 27% | 140 | 126 | 133 | 106 |
| | 40% | 140 | 126 | 133 | 105 |
| | 50% | 140 | 126 | 133 | 105 |
| | 50% | 140 | 126 | 133 | 105 |

TABLE 5B

| Conc. Flow | Perm. Flow | Perm flow | Conc. | Perm | % Cond. |
|---|---|---|---|---|---|
| (gpm) | (ml/min) | (GFD) | Cond. | Cond. | Reject |
| 16.1 | 2351 | 52.7 | 820 | 41 | 95.0% |
| 7.1 | 1798 | 40.3 | 947 | 65 | 93.1% |
| 16.2 | 2340 | 52.4 | 753 | 35 | 95.4% |
| 16.2 | 2213 | 49.6 | | | |
| 16.2 | 2250 | 50.4 | 1029 | 49 | 95.2% |
| 16.2 | 2130 | 47.7 | 1256 | 57 | 95.5% |
| 16.2 | 2238 | 50.1 | 1733 | 78 | 95.5% |

TABLE 6A

| | Con- | | | | | | | | |
|---|---|---|---|---|---|---|---|---|---|
| | cen- | | | Conductivity | | | | | |
| Mem- | tra- | pH | | (micromhos) | | Ca (ppm) | | Mg (ppm) | |
| brane | tion | Conc. | Perm. | Conc. | Perm. | Conc. | Perm. | Conc. | Perm. |
| Nano | 10% | 9.17 | 9.55 | 753 | 35 | 3.42 | 0 | 31.5 | 0.2 |
| 350 | | | | | | | | | |
| | 40% | 9.11 | 9.6 | 1029 | 49 | 4.35 | 0 | 38.4 | 0.3 |
| | 50% | 9.06 | 9.63 | 1256 | 57 | 4.28 | 0 | 48.7 | 0.4 |

TABLE 6B

| | | | | | | | | Total | |
|---|---|---|---|---|---|---|---|---|---|
| Total | | | | | | | | Alkalinity | |
| Hardness | | | | Silt | | P-Alkalinity | | (meq/l) | |
| (ppm CaCo₃) | | SiO₂(ppm) | | Density Index | | (meq/l) | | (pH7) | |
| Conc. | Perm. | Conc. | Perm. | Conc. | Perm. | Conc. | Perm. | Conc. | Perm. |
| 120 | 6 | 18.1 | 2.1 | 4.04 | 0.33 | 0.4 | 0.1 | 0.9 | 0.15 |
| 152 | 8 | 24.8 | 2.8 | | | | | | |
| 214 | 10 | 28.5 | 3.2 | 5.3 | 0.53 | 0.9 | 0.1 | 1.2 | 0.15 |

### EXAMPLE 4

After cleaning the skid and membranes, the Zeta Rod unit and controls were installed, along with the Graver® stainless steel membrane. The first test with the Zeta Rod unit was similar to the previous tests without the unit. Again 20 gallons of deionized water were added, and the salt additions (starting with an addition equal to 100% of observed hardness and silica, 1.0×) were made. The solution was circulated for one hour at the same parameters as used before with the stainless membrane, with readings taken every 15 minutes, and feed and permeate samples taken 30 minutes into operation at each concentration. The initial addition of 43.7065 grams was followed by additions of 21.8582 (1.5×), 21.8581 (2.0×), 21.8592 (2.5×), and 21.8310 (3.0×) grams. The salt amounts used were the following:

Calcium carbonate: 61.3082 grams

Calcium chloride dihydrate: 10.0092 grams

Magnesium carbonate: 5.7333 grams

Magnesium sulfate: 19.1520 grams

Sodium carbonate: 24.1677 grams

Sodium meta-silicate (Na₂SiO₃*9H₂O): 10.7426 grams

Experimental results are shown in Tables 7A-8B.

TABLE 7A

| | | Mem. Feed | Mem. Outlet | |
|---|---|---|---|---|
| Membrane | Concentration | (PSI) | (PSI) | TMP |
| 0.1 Graver | 1X | 100 | 95 | 97.5 |
| | 1.5X | 100 | 95 | 97.5 |
| | 2.0X | 100 | 95 | 97.5 |
| | 2.5X | 100 | 95 | 97.5 |
| | 3.0X | 100 | 95 | 97.5 |

TABLE 7B

| Conc. Temp. | Conc. Flow | Perm. Flow | | |
|---|---|---|---|---|
| (° F.) | (gpm) | (ml/min) | Perm flow (GFD) | GFD/TMP |
| 107 | 19.6 | 1028 | 1037.3 | 10.6 |
| 106 | 19.6 | 983 | 991.8 | 10.2 |
| 105 | 19.7 | 981 | 989.8 | 10.2 |
| 107 | 19.6 | 1424 | 1436.8 | 14.7 |
| 107 | 19.7 | 1373 | 1385.4 | 14.2 |

TABLE 8A

| | | | | Conductivity | | | |
|---|---|---|---|---|---|---|---|
| | | pH | | (micromhos) | | Ca (ppm) | |
| Membrane | Concentration | Conc. | Perm. | Conc. | Perm. | Conc. | Perm. |
| 0.1 Graver | 1X | 9.82 | 9.63 | 365 | 330 | 80.2 | 6.9 |
| | 1.5X | 9.98 | 9.91 | 495 | 485 | 142.6 | 11.8 |
| | 2.0X | 9.99 | 10.1 | 603 | 623 | 193 | 14.4 |
| | 2.5X | 10 | 10 | 704 | 706 | 254 | 2.4 |
| | 3.0X | 9.86 | 9.95 | 788 | 794 | 386 | 2.26 |

TABLE 8B

| | | | | | | | | Total Alkalinity |
|---|---|---|---|---|---|---|---|---|
| | | Total Hardness | | | | Silt Density | P-Alkalinity | (meq/l) |
| Mg (ppm) | | (ppm CaCO₃) | | SiO₂ (ppm) | | Index | (meq/l) | (pH 7) |
| Conc. | Perm. | Conc. | Perm. | Conc. | Perm. | Perm. | Perm. | Perm. |
| 29.6 | 21.6 | 278 | 86 | 17.5 | 21.2 | 0.66 | 1 | 1.2 |
| 45 | 32.9 | 418 | 112 | 15.2 | 16.2 | | | |
| 59 | 43.3 | 578 | 152 | 24.5 | 22.6 | | | |
| 73.3 | 41.1 | 744 | 144 | 20.9 | 21.8 | | | |
| 90.9 | 38.6 | 1165 | 158 | 24.3 | 25.1 | 1.11 | 1.3 | 1.5 |

### EXAMPLE 5

The decision was made to use the Graver® membrane to concentrate the 300% feed (3.0×) solution without testing the Duramem® ceramic membranes. Thus, once the last addition was made and the testing associated with it was complete, the permeate was directed to a separate container. The feed solution was concentrated 75% (to 5 gallons), with readings and samples taken every 12.5% (2.5 gallons). After the concentration, the concentrate was circulated through the membrane for a period of 12 hours at 100-psi inlet pressure, 15-fps cross-flow rate, and 100-110° F., with occasional backpulsing. Experimental results are given in Tables 9A-10B below.

TABLE 9A

| | Mem. Feed | Mem. Outlet | | Conc. Temp. |
|---|---|---|---|---|
| Concentration | (PSI) | (PSI) | TMP | (° F.) |
| 12.50% | 100 | 95 | 97.5 | 107 |
| 25% | 100 | 95 | 97.5 | 107 |
| 37.50% | 100 | 95 | 97.5 | 107 |
| 50% | 100 | 95 | 97.5 | 107 |
| 62.50% | 100 | 95 | 97.5 | 107 |
| 75% | 100 | 95 | 97.5 | 107 |
| 75% | 100 | 95 | 97.5 | 109 |
| 75% | 100 | 95 | 97.5 | 103 |
| 37.50% | 100 | 95 | 97.5 | 105 |

TABLE 9B

| Conc. Flow | Perm. Flow | Perm flow | |
|---|---|---|---|
| (gpm) | (ml/min) | (GFD) | GFD/TMP |
| 19.7 | 1420 | 1432.8 | 14.7 |
| 19.7 | 1362 | 1374.3 | 14.1 |
| 19.7 | 1301 | 1312.7 | 13.5 |
| 19.7 | 1230 | 1241.1 | 12.7 |
| 19.7 | 1178 | 1188.6 | 12.2 |
| 19.7 | 1160 | 1170.4 | 12.0 |
| 19.7 | 1003 | 1012.0 | 10.4 |
| 19.7 | 729 | 735.6 | 7.5 |
| 19.7 | 706 | 712.4 | 7.3 |

TABLE 10A

| | |
|---|---|
| | Conductivity |
| pH | (micromhos) |

| Membrane | Concentration | Conc. | Perm. | Conc. | Perm. |
|---|---|---|---|---|---|
| 0.1 Graver | 25% | 9.85 | 9.94 | 784 | 782 |
| | 50% | 9.88 | 9.96 | 786 | 785 |
| | 75% | 9.87 | 9.91 | 790 | 782 |
| | 37.50% | 9.55 | 9.3 | 498 | 465 |

TABLE 10B

| | | | | Total Hardness | | | |
|---|---|---|---|---|---|---|---|
| Ca (ppm) | | Mg (ppm) | | (ppm CaCO₃) | | SiO₂ (ppm) | |
| Conc. | Perm. | Conc. | Perm. | Conc. | Perm. | Conc. | Perm. |
| 450 | 1.73 | 97.6 | 36.3 | 1085 | 154 | 11.44 | 12.3 |
| 605 | 1.5 | 118 | 35.9 | 1555 | 158 | 8.7 | 10.9 |
| 848 | 1.56 | 151 | 35.8 | 2430 | 144 | 13.3 | 11.7 |
| 379 | 4.12 | 64 | 31 | 1154 | 118 | 6.6 | 10 |

### EXAMPLE 6

After this, the skid was drained, and the ESNA nanofilter was installed. After placing the microfiltration permeate in the skid, the nanofilter was operated at 140-psi inlet pressure, 16.0 gpm feed rate, and 100-110° F. for four hours, with hourly readings taken as shown in Tables 11A-12B, after which the skid was drained.

TABLE 11A

| | | | Mem. | | |
|---|---|---|---|---|---|
| | | Mem. | Outlet | | Conc. |
| Membrane | Concentration | Feed (PSI) | (PSI) | TMP | Temp. (° F.) |
| Nano 350 | Initial | 140 | 126 | 133 | 107 |
| | 26.7% | 140 | 126 | 133 | 106 |
| | 44.0% | 140 | 126 | 133 | 105 |
| | 50.0% | 140 | 126 | 133 | 107 |
| | 66.7% | 140 | 126 | 133 | 106 |
| | 83.0% | 140 | 126 | 133 | 104 |
| Nano 350 | | | | | |
| 2 hours | 83.0% | 140 | 126 | 133 | 106 |
| 2 hours | 83.0% | 100 | 97 | 98.5 | 106 |
| 2 hours | 83.0% | 100 | 97 | 98.5 | 105 |
| Nano 350 | | | | | |
| 3 hours | 80.0% | 140 | 126 | 133 | 107 |

TABLE 11B

| Conc. Flow | Perm. | Perm flow | | | |
|---|---|---|---|---|---|
| (gpm) | Flow (ml/min) | (GFD) | Conc. Cond. | Perm Cond. | % Cond. Reject |
| 16 | 2376 | 53.2 | 1039 | 85 | 91.8% |
| 16 | 2309 | 51.7 | | | |
| 16 | 2174 | 48.7 | 2440 | 126 | 94.8% |
| 16 | 2272 | 50.9 | | | |
| 16 | 2122 | 47.5 | 3060 | 149 | 95.1% |
| 16 | 1953 | 43.7 | 3310 | 158 | 95.2% |
| 16 | 1982 | 44.4 | 3389 | 150 | 95.6% |
| 7.2 | 1400 | 31.4 | 3320 | 186 | 94.4% |
| 7.2 | 1369 | 30.7 | 3295 | 174 | 94.7% |
| 16 | 2067 | 46.3 | 3960 | 126 | 96.8% |

TABLE 12A

| | Con- | | | | | | | | |
|---|---|---|---|---|---|---|---|---|---|
| | cen- | | | Conductivity | | | | | |
| Mem- | tra- | pH | | (micromhos) | | Ca (ppm) | | Mg (ppm) | |
| brane | tion | Conc. | Perm. | Conc. | Perm. | Conc. | Perm. | Conc. | Perm. |
| Nano | Initial | 9.91 | 10.2 | 1039 | 85 | 9.53 | 0.1 | 48.4 | 0.3 |
| 350 | 83% | 9.69 | 10.14 | 3310 | 158 | 17.8 | 0.22 | 148.9 | 0.96 |

TABLE 12B

| | | | | | | | | Total | |
|---|---|---|---|---|---|---|---|---|---|
| | | | | | | | | Alkalinity | |
| Total Hardness | | | | Silt Density | | P-Alkalinity | | (meq/l) | |
| (ppm CaCO₃) | | SiO₂ (ppm) | | Index | | (meq/l) | | (pH 7) | |
| Conc. | Perm. | Conc. | Perm. | Conc. | Perm. | Conc. | Perm. | Conc. | Perm. |
| 172 | 12 | 6.6 | 0.6 | 1.71 | 0.53 | 1.45 | 0.1 | 2.2 | 0.4 |
| 542 | 10 | 19.38 | 1.35 | 2.08 | 0.71 | 2.5 | 0.2 | 4.4 | 0.3 |

### EXAMPLE 7

After this testing was complete, the unit was cleaned and the 0.01-micron Duramem® membrane installed. The decision was made to make a larger amount of feed solution to attempt to further test the ability of the Zeta Rod unit to operate at higher concentrations. A total of 50 gallons of 300% (3.0×) concentrated feed were fed to the 0.01-micron ceramic membrane, and it was operated at the same conditions as in previous tests. The 50-gallon feed was in the form of an initial 20-gallon deionized water feed with 131.1067 grams of mixed salts, followed by 310-gallon deionized water additions with 65.5865, 65.5864, 65.5761 grams of mixed salts respectively. The total amounts of each chemical were the following:

Calcium carbonate: 153.2980 grams

Calcium chloride dihydrate: 25.0356 grams

Magnesium carbonate: 14.3843 grams

Magnesium sulfate: 47.8756 grams

Sodium carbonate: 60.4078 grams

Sodium meta-silicate (Na₂SiO₃*9H₂O): 26.8544 grams.

Experimental results are given in Tables 13A-14B below.

TABLE 13A

| | | Mem. Feed | Mem. Outlet | |
|---|---|---|---|---|
| Membrane | Concentration | (PSI) | (PSI) | IMP |
| 0.01 Duramem | 3X | 75 | 61 | 68 |
| | 20% | 75 | 61 | 68 |
| | 40% | 75 | 61 | 68 |
| | 60% | 75 | 61 | 68 |
| | 80% | 75 | 61 | 68 |
| | 85% | 75 | 61 | 68 |
| | 85% | 75 | 61 | 68 |
| | 90% | 75 | 61 | 68 |

TABLE 13B

| Conc. Temp. | Conc. Flow | Perm. Flow | Perm | |
|---|---|---|---|---|
| (° F.) | (gpm) | (ml/min) | flow (GFD) | GFD/TMP |
| 105 | 14 | 2622 | 832.4 | 12.2 |
| 105 | 14 | 3009 | 955.2 | 14.0 |
| 105 | 14 | 3059 | 971.1 | 14.3 |
| 104 | 14 | 3101 | 984.4 | 14.5 |
| 105 | 14 | 3333 | 1058.1 | 15.6 |
| 106 | 14 | 3368 | 1069.2 | 15.7 |
| 103 | 14 | 3455 | 1096.8 | 16.1 |
| 104 | 14 | 3460 | 1098.4 | 16.2 |

TABLE 14A

| | | | | Conductivity | | | | | |
|---|---|---|---|---|---|---|---|---|---|
| | | pH | | (micromhos) | | Ca (ppm) | | Mg (ppm) | |
| Membrane | Concentration | Conc. | Perm. | Conc. | Perm. | Conc. | Perm. | Conc. | Perm. |
| 0.01 Duramem | 3x | 9.75 | 9.63 | 569 | 511 | 266.3 | 2.31 | 42.2 | 35.2 |
| | 85% | 9.96 | 10.01 | 1028 | 1003 | 755 | 16.08 | 151 | 45 |

TABLE 14B

| | | | | | | Total |
|---|---|---|---|---|---|---|
| | | | | | | Alkalinity |
| Total Hardness | | | | Silt Density | P-Alkalinity | (meq/l) |
| (ppm CaCO₃) | | SiO₂ (ppm) | | Index | (meq/l) | (pH 7) |
| Conc. | Perm. | Conc. | Perm. | Perm. | Perm. | Perm. |
| 1036 | 110 | 7.95 | 5.38 | 0.59 | 0.5 | 0.95 |
| 3176 | 174 | 9.98 | 5.5 | 0.88 | 1.3 | 1.55 |

### EXAMPLE 8

After using the 0.01-micron ceramic membrane to produce 42.5 gallons of additional microfiltration permeate, the nanofilter was installed into the skid system, and used to concentrate the microfilter permeate. The operating conditions were 140-psi inlet pressure, 16.0-gpm feed rate, and 100-110° F. A total of 37.5 gallons of permeate were produced, after which the nanofilter was operated for 12 hours with hourly readings taken. The permeate from the initial 20-gallon feed test was then added to the feed tank, as well as two additions of 36.0480 grams of sodium meta-silicate while the nanofilter operated over a period of two working days. Experimental results are shown in Tables 15A-16B. After these tests were concluded, the skid was drained, and the skid and membranes cleaned.

TABLE 15A

| | | | Mem. | | |
|---|---|---|---|---|---|
| | | Mem. | Outlet | | Conc. |
| Membrane | Time | Feed (PSI) | (PSI) | TMP | Temp. (° F.) |
| Nano 350 | 8:15 | 140 | 126 | 133 | 108 |
| | 8:30 | | | | |
| | 8:45 | 140 | 123 | 131.5 | 106 |
| | 9:45 | 140 | 122 | 131 | 104 |
| | 10:51 | 142 | 122 | 132 | 104 |
| | 11:45 | 142 | 122 | 132 | 104 |
| | 12:05 | | | | |
| | 12:20 | 143 | 121 | 132 | 104 |
| | 13:25 | 143 | 121 | 132 | 104 |
| | 14:20 | 143 | 121 | 132 | 106 |
| | 15:20 | 143 | 121 | 132 | 108 |
| | 16:15 | 143 | 121 | 132 | 105 |

TABLE 15B

| Conc. Flow | Perm. | Perm flow | | | |
|---|---|---|---|---|---|
| (gpm) | Flow (ml/mm) | (GFD) | Conc. Cond. | Perm Cond. | % Cond. Reject |
| 16.1 | 2140 | 47.9 | 3660 | 122 | 96.7% |
| 15.8 | 1800 | 40.3 | 3930 | 156 | 96.0% |
| 15.9 | 1440 | 32.3 | | | |
| 15.8 | 1300 | 29.1 | 3470 | 160 | 95.4% |
| 15.8 | 1280 | 28.7 | 3660 | 159 | 95.7% |
| 15.6 | 1060 | 23.7 | 3800 | 206 | 94.6% |
| 15.6 | 760 | 17.0 | | | |
| 15.6 | 792 | 17.7 | | | |
| 15.6 | 760 | 17.0 | 4210 | 230 | 94.5% |
| 15.6 | 800 | 17.9 | 3650 | 168 | 95.4% |

TABLE 16A

| | | | |
|---|---|---|---|
| Time | pH | Conductivity | Ca (ppm) |

| Nano 350 | Conc. | Perm. | Conc. | Perm. | Conc. | Perm. |
|---|---|---|---|---|---|---|
| 11:45 | 9.24 | 8.21 | 3660 | 159 | 16.7 | 3.33 |
| 12:20 | 9.34 | 8.07 | 3800 | 206 | 17.6 | 3.1 |
| 16:15 | 9.55 | 9.4 | 3650 | 168 | 10.9 | 4.75 |

TABLE 16B

| | | |
|---|---|---|
| Mg (ppm) | Total Hardness | SiO2 |

| Conc. | Perm. | Conc. | Perm. | Conc. | Perm. |
|---|---|---|---|---|---|
| 112.7 | 0 | 425 | 10 | 60.7 | 6.53 |
| 93 | 0 | 265 | 5 | 82.9 | 11.1 |
| 60.6 | 0 | 180 | 10 | 66.1 | 10.32 |

### EXAMPLE 9

This example is for concentrated hardness testing. After the pilot skid and membranes were cleaned, and the Zeta Rod unit removed, the Graver® unit was installed. A 50-gallon concentrated hardness solution was then prepared in a separate container. This solution was prepared by adding 1,889.3 grams of calcium carbonate and 787.8 grams of magnesium carbonate to the 50 gallons of deionized water. (Representing a 1% solids solution.) 20 gallons of this solution were then placed in the skid feed tank. The solution was circulated, with the membrane bypassed, while being heated to 100-110° F. The solution was then passed through the membrane at 16.0-gpm feed (12.2 ft/sec cross-flow) and 100-psi inlet pressure. These conditions were maintained for two hours, with readings taken every 30 minutes, and samples of the feed and permeate taken one hour into operation. After two hours, the Graver® membrane was removed, and the 0.01-micron Duramem® unit installed. The solution was circulated through it for two hours as well at 75-psi inlet, 14.0 gpm, and 100-110° F., with half-hour readings and samples taken after one hour. Finally the 0.2-micron Duramem® unit was installed, and the solution circulated at similar conditions.

After two hours of operation, the 0.2-micron unit was used to concentrate the feed solution by 50% (25 gallons) (2% solids solution) at the same operating conditions with feed being pumped from the mixing container to the feed tank as needed. The 0.2-micron unit was then operated at this concentration for two hours, with half-hour readings and samples taken. The 0.01-micron unit was then installed and run for two hours, after which the Graver® unit was installed and operated for two hours. Readings and samples were taken for each membrane.

The 0.2-micron Duramem® unit was then installed and used to concentrate the feed by half again (to 75% or 12.5 gallons) (4% solids solution). This membrane and the other two membranes were then operated for two hours at this concentration, with half-hour readings and samples taken. Finally, the Graver® unit was used to concentrate the feed solution further to 90% concentration (5 gallons) (4.5% solids solution). The Graver® membrane was operated for three hours at this final concentration, after which the 0.2-micron Duramem® unit was installed and operated for two working days. Samples and periodic readings were taken for both membranes during operation as shown in Tables 17A-18D, after which the skid was drained, and the membranes cleaned.

TABLE 17A

| | | Mem. Feed | Mem. Outlet | |
|---|---|---|---|---|
| Membrane | Concentration | (PSI) | (PSI) | TMP |
| 0.1 Graver | ˜1% Solids | 100 | 95 | 97.5 |
| 0.2 Duramem | | 75 | 59 | 67 |
| 0.01 Duramem | | 75 | 62 | 68.5 |
| 0.1 Graver | ˜2% Solids | 100 | 96 | 98 |
| 0.2 Duramem | | 75 | 58 | 66.5 |
| 0.01 Duramem | | 75 | 60 | 67.5 |
| 0.1 Graver | ˜4% Solids | 100 | 95 | 97.5 |
| 0.2 Duramem | | 75 | 53 | 64 |
| 0.01 Duramem | | 75 | 60 | 67.5 |
| 0.1 Graver | ˜4.5% Solids | 100 | 95 | 97.5 |
| 0.2 Duramem | | 75 | 57 | 66 |
| 0.2 Duramem | | 75 | 52 | 63.5 |
| Extended Ops | | | | |
| 2 days | | | | |

TABLE 17B

| Conc. Temp. | Conc. Flow | Perm. Flow | Perm | |
|---|---|---|---|---|
| (° F.) | (gpm) | (ml/min) | flow (GFD) | GFD/TMP |
| 108 | 16 | 1801 | 1817.2 | 18.6 |
| 108 | 14 | 11201 | 3555.9 | 53.1 |
| 108 | 14 | 3647 | 1157.8 | 16.9 |
| 107 | 16 | 1253 | 1264.3 | 12.9 |
| 108 | 14 | 8251 | 2619.4 | 39.4 |
| 108 | 14 | 3879 | 1231.4 | 18.2 |
| 108 | 16 | 1158 | 1168.4 | 12.0 |
| 107 | 14 | 7280 | 2311.1 | 36.1 |
| 107 | 14 | 4082 | 1295.9 | 19.2 |
| 108 | 16 | 1083 | 1092.7 | 11.2 |
| 107 | 14.2 | 4797 | 1522.9 | 23.1 |
| 108 | 14 | 3469 | 1101.3 | 17.3 |

TABLE 18A

pH

| Membrane | Concentration | Conc. | Perm. |
|---|---|---|---|
| 0.1 Graver | ˜1% Solids | 9.57 | 9.53 |
| 0.2 Duramem | | 9.57 | 9.52 |
| 0.01 Duramem | | 9.57 | 9.54 |
| 0.1 Graver | ˜2% Solids | 9.52 | 9.5 |
| 0.2 Duramem | | 9.52 | 9.5 |
| 0.01 Duramem | | 9.52 | 9.52 |
| 0.1 Graver | ˜4% Solids | 9.51 | 9.5 |
| 0.2 Duramem | | 9.51 | 9.46 |
| 0.01 Duramem | | 9.51 | 9.41 |
| 0.1 Graver | ˜4.5% Solids | 9.36 | 9.36 |
| 0.2 Duramem | | 9.36 | 9.16 |

TABLE 18B

| | |
|---|---|
| Conductivity (micromhos) | Ca (ppm) |

| Conc. | Perm. | Conc. | Perm. |
|---|---|---|---|
| 342 | 332 | 1819 | 12.4 |
| 342 | 340 | 1819 | 10.49 |
| 342 | 332 | 1819 | 10.58 |
| 436 | 406 | 5428 | 6.58 |
| 436 | 376 | 5428 | 2.48 |
| 436 | 410 | 5428 | 2.04 |
| 519 | 443 | 8726 | 2.6 |
| 519 | 426 | 8726 | 7.95 |
| 519 | 431 | 8726 | 2.52 |
| 466 | 465 | 10669 | 3.22 |
| 466 | 613 | 10669 | 2.79 |

TABLE 18C

| | | Total Hardness (ppm | | | |
|---|---|---|---|---|---|
| Mg (ppm) | | CaCO₃) | | Total Solids (mg/kg) | |
| Conc. | Perm. | Conc. | Perm. | Conc. | Perm. |
| 1628 | 162.8 | 11700 | 134 | 8432 | |
| 1628 | 149 | 11700 | 146 | 8432 | |
| 1628 | 162.8 | 11700 | 144 | 8432 | |
| 2620 | 51.6 | 21040 | 148 | 21705 | |
| 2620 | 50.8 | 21040 | 136 | 21705 | |
| 2620 | 50.7 | 21040 | 144 | 21705 | |
| 5479 | 50.71 | 37500 | 156 | 39111 | |
| 5479 | 43.7 | 37500 | 140 | 39111 | |
| 5479 | 49.9 | 37500 | 156 | 39111 | |
| 5959 | 47.13 | 48000 | 178 | 46780 | |
| 5959 | 72.7 | 48000 | 262 | 46780 | |

TABLE 18D

| Total Suspended Solids (mg/kg) | | Total Dissolved Solids (mg/kg) | |
|---|---|---|---|
| Conc. | Perm. | Conc. | Perm. |
| 8024 | | 254 | 238 |
| 8024 | | 254 | 256 |
| 8024 | | 254 | 276 |
| 21479 | | 226 | 218 |
| 21479 | | 226 | 273 |
| 21479 | | 226 | 233 |
| 38896 | | 215 | 233 |
| 38896 | | 215 | 211 |
| 38896 | | 215 | 230 |
| 46453 | | 327 | 305 |
| 46453 | | 327 | 376 |

The present invention has been described with reference to certain preferred and alternative embodiments that are intended to be exemplary only and not limiting to the full scope of the present invention as set forth in the appended claims.

What is claimed is:

1. A method of removing a dissolved first substance from a solution, comprising the steps of:
(a) diverting a feed stream of said solution into a cross flow filtration loop circulating retentate across a cross flow filter;
(b) maintaining a saturated solution of said dissolved first substance in said retentate circulating in said cross flow filtration loop;
(c) circulating said retentate in said cross flow filtration loop with sufficient agitation to effect precipitation of a least a portion of said dissolved first substance as a first precipitate;
(d) removing a permeate stream from said cross flow filter;
(e) removing a concentrate stream from said retentate in said cross flow filtration loop;
(f) balancing a rate of withdrawal of said concentrate stream with a rate of introduction of said feed stream to maximize a concentration of said first precipitate in said cross flow filtration loop consistent with an optimum flux of said permeate across said cross flow filter; and
(g) returning said permeate stream to said solution.

2. The method of claim 1 wherein step (b) comprises maintaining said retentate at a temperature at which said dissolved first substance is saturated in said retentate.

3. The method of claim 1 wherein step (b) comprises maintaining said retentate at a pH at which said dissolved first substance is saturated in said retentate.

4. The method of claim 1, further comprising the step of polishing said permeate stream by passing at least a portion of said permeate stream through a polisher before returning said permeate stream to said solution.

5. The method of claim 4 wherein said polisher is a nanofilter.

6. The method of claim 4 wherein said polisher is a reverse osmosis system.

7. The method of claim 4 wherein at least a portion of a reject stream from said polisher is returned to said retentate.

8. The method of claim 1 wherein said feed stream includes organics and further comprising the step of adding an organic scavenger to said retentate.

9. The method of claim 1 further comprising the step of dewatering said concentrate stream.

10. The method of claim 9 wherein at least a portion of a reclaimed water stream from said dewatering step is returned to said retentate.

11. The method of claim 1 wherein said feed stream contains microbiological organisms and further comprising the step of adding a biocide to said feed stream.

12. The method of claim 1 further comprising the step of applying a dispersant to said solution.

13. The method of claim 12 wherein said dispersant is a chemical dispersant.

14. The method of claim 12 wherein said dispersant is an electronic dispersant.

15. The method of claim 1 wherein said solution contains a dissolved second substance, further comprising the steps of adding a precipitant to said solution to precipitate said second dissolved substance as a second precipitate and removing said second precipitate in said concentrate stream.

16. A method for treating circulating cooling water containing calcium carbonate, comprising the steps of:
(a) diverting a feed stream from said circulating cooling water into a cross flow filtration loop circulating retentate across a cross flow filter;
(b) maintaining a saturated solution of said calcium carbonate in said retentate circulating in said cross flow filtration loop;
(c) circulating said retentate in said cross flow filtration loop with sufficient agitation to effect precipitation of at least a portion of said calcium carbonate as a calcium carbonate precipitate;
(d) removing a permeate stream from said cross flow filter;
(e) removing a concentrate stream containing said calcium carbonate precipitate from said cross flow filtration loop;
(f) balancing a rate of withdrawal of said concentrate stream with a rate of introduction of said feed stream to maximize a concentration of said first precipitate in said cross flow filtration loop consistent with an optimum flux of said permeate across said cross flow filter; and
(g) returning said permeate stream to said circulating cooling water.

17. The method of claim 16 wherein step (b) comprises maintaining said retentate at a temperature at which said calcium carbonate is saturated in said retentate.

18. The method of claim 16 wherein step (b) comprises maintaining said retentate at a pH at which said calcium carbonate is saturated in said retentate.

19. The method of claim 17 wherein said circulating cooling water is circulated through a heat exchanger having a hot side and a cold side and further wherein step (b) comprises diverting said feed stream from said hot side of said condenser.

20. The method of claim 16, further comprising the step of polishing said permeate stream by passing at least a portion of said permeate stream through a polisher before returning said permeate stream to said circulating cooling water.

21. The method of claim 20 wherein said polisher is a nanofilter.

22. The method of claim 20 wherein said polisher is a reverse osmosis system.

23. The method of claim 20 wherein at least a portion of a reject stream from said polisher is returned to said cross flow filtration loop.

24. The method of claim 16 wherein said feed stream includes organics and further comprising the step of adding an organic scavenger to said cross flow filtration loop.

25. The method of claim 16 further comprising the step of dewatering said concentrate stream.

26. The method of claim 25 further comprising the step of returning at least a portion of a reclaimed water stream from said dewatering step to said cross flow filtration loop.

27. The method of claim 16 wherein said circulating cooling water includes microbiological organisms and further comprising the step of adding a biocide to said circulating cooling water.

28. The method of claim 16 further comprising the step of applying a dispersant to said circulating cooling water.

29. The method of claim 28 wherein said dispersant is a chemical dispersant.

30. The method of claim 28 wherein said dispersant is an electronic dispersant.

31. The method of claim 16 wherein said cooling water contains a dissolved second substance, further comprising the steps of adding a precipitant to said solution to precipitate said second dissolved substance as a second precipitate and removing said second precipitate in said concentrate stream.

32. The method of claim 31 where said dissolved second substance is silica and said precipitant is magnesium hydroxide.

33. The method of claim 16 wherein said cross flow filter is a microfilter.

34. The method of claim 16 wherein said cross flow filter is a nanofilter.

35. The method of claim 16 wherein said cross flow filter is a wide channel membrane filter.

36. The method of claim 35 wherein said cross flow filter is a sintered metal filter.

37. The method of claim 35 wherein said cross flow filter is a ceramic filter.

38. The method of claim 35 wherein said cross flow filter is a moving membrane filter.

39. The method of claim 24 wherein said organic scavenger is activated carbon.

40. The method of claim 25 wherein said dewatering step comprises passing said concentrate stream through a filtering press.

41. The method of claim 25 wherein said dewatering step comprises passing said concentrate stream through a moving membrane filter.

42. The method of claim 25 wherein said dewatering step comprises passing said concentrate stream through a precipitation tank.

43. The method of claim 25 wherein said dewatering step comprises passing said concentrate stream through a centrifuge.

44. The method of claim 25 wherein said dewatering step comprises passing said concentrate stream through a belt press.

45. The method of claim 25 wherein said dewatering step comprises passing said concentrate stream through a plate and frame filtering press.

46. The method of claim 25 wherein said dewatering step comprises passing said concentrate stream through a cyclonic separator.
